(19) United States
(12) Patent Application Publication
(10) Pub. No.: US 2010/0096559 A1
(43) Pub. Date: Apr. 22, 2010

(54) ULTRAVIOLET DETECTOR AND DOSIMETER

(76) Inventors: Kui Yao, Connexis (SG); Bee Keen Gan, Connexis (SG); Szu Cheng Lai, Connexis (SG)

Correspondence Address: SCHWEGMAN, LUNDBERG & WOESSNER, P.A., P.O. BOX 2938, MINNEAPOLIS, MN, 55402, US

(21) Appl. No.: 12/451,271

(22) PCT Filed: May 2, 2008
(86) PCT No.: PCT/SG2008/000154

§ 371 Date: Nov. 3, 2009

Related U.S. Application Data
(60) Provisional application No. 60/915,709, filed on May 3, 2007.

(51) Int. Cl. G01J 1/46; G01J 1/44

(52) U.S. Cl. 250/372

(57) ABSTRACT

A UV light detector is disclosed that has a UV sensing element comprising a substrate and a thin film layer formed on the substrate. The thin film layer is for receiving and converting UV light into electricity for a photovoltaic output. First and second electrodes are formed on one surface of the thin film layer and are configured to form an electric polarization in the thin film layer between the first and second electrodes and to collect the photovoltaic output. There is also an amplifier and an output display. The UV sensing element is configured to collect the photovoltaic output, the amplifier being configured to receive the photovoltaic output from the UV sensing element, the output display being configured to provide a display when UV light is received at the one surface, the display being derived from the photovoltaic output. A UV dosimeter is also disclosed.

### REFERENCE TO RELATED APPLICATION

Reference is made to our earlier U.S. patent application Ser. No. 11/386,295 filed 21 Mar. 2006 for an invention titled “Thin Film Photovoltaic Device” published on 28 Sep. 2006 as US2006/0213549 (our “earlier application”), the contents of which are hereby incorporated by reference as if disclosed herein in their entirety.

### TECHNICAL FIELD

This invention relates to an ultraviolet (UV) detector and dosimeter and refers particularly, though not exclusively, to an ultraviolet detector and dosimeter using a photovoltaic thin film as a sensing element.

### BACKGROUND

Ultraviolet (“UV”) light in solar radiation has pronounced effects on human health. UV radiation is subdivided according to wavelength into UV-A (320 to 400 nm), UV-B (290 to 320 nm), and UV-C (200 to 290 nm). Usually, only UV-A and UV-B can penetrate the atmosphere and reach the surface of the earth. UV-A is responsible for tanning, and plays a role in skin cancer. It is also the cause of eye cataracts, solar retinitis and corneal dystrophies. UV-B is considered to be the cause of skin cancer in humans. In addition, the interaction between UV-A and UV-B radiation may have a synergistic skin-cancer causing-effect. This combination is a cause of skin aging and wrinkling.

According to information provided by the World Health Organization, about 2 to 3 million non-melanoma skin cancers and approximately 130,000 malignant melanomas occur globally each year. This substantially contributes to the mortality rate in the fair-skinned population. About 12 to 15 million people worldwide become blind from cataracts annually, of which up to 20% may be caused or enhanced by sun exposure.

With reduction of the stratospheric ozone layer through anthropogenic influence, the problems of UV effects on human health may become even more severe. Nevertheless, small amount of UV is beneficial, and is essential in the production of Vitamin D. In addition, because skin type and health condition vary between individuals, UV exposure levels that may cause significant damage to one person may be benign and even beneficial to another. Therefore, it is necessary to monitor and manage UV exposure for individuals. In view of this, the use of personal portable UV detectors is of advantage, particularly for those whose skin or eyes are more liable to damage under UV light.

Among existing UV detectors, photon detectors are commonly utilized at UV wavelengths due to their greater sensitivity. UV photon detectors have traditionally been divided into two distinct classes: photographic and photoelectric. Due to the quantitative measurement capability, semiconductor photoelectric detectors are competitive for personal healthcare applications. Semiconductors with a large band-gap, such as GaN, AlN, and SiC, have been explored for UV detection. However, detectors made out of these materials, or combinations of them, are usually obtained via expensive deposition methods in a vacuum chamber. Methods such as, for example, metal organic chemical vapor deposition (MOCVD) or molecular beam epitaxy (MBE) may be used. As semiconductors with a relatively small band-gap, such as Si, are also sensitive to longer wavelength light than UV, a low pass filter that only allows UV light to pass is needed, which is costly and makes the device structure more complicated. In addition, such filters usually have a poor transparency for UV light wavelengths that are dangerous to human health.

Semiconductor photovoltaic effects, which are based on a p-n junction or Schottky barrier, can only produce a photo-voltage typically below one volt. UV sensors using the photovoltaic effect in a ferroelectric thin film cannot generate a larger voltage due to the small thickness of the ferroelectric thin film and its constraint on the voltage. The small voltage limits the ability of the photovoltaic element to drive the circuit.

In UV sensors, UV light must penetrate at least one metal layer or a semiconductor layer. For example, UV light needs to pass through the top electrode layer in a ferroelectric thin film with sandwiched top and bottom electrodes; or the metal layer in a Schottky barrier; or one of the semiconductor layers in a p-n junction. As metal electrodes, including so-called transparent electrodes, do not have a satisfactory transparency for UV light in the wavelengths that are dangerous to human health, UV energy loss is significant due to the penetration of the top electrode layers. The dependence of the transparency on the UV wavelength, and incidence angle for any layers at the top of the photovoltaic region, also cause the spectrum as received to be changed. Also, the acceptance angle is narrow.

### SUMMARY

According to an exemplary aspect, there is provided a UV light detector comprising a UV sensing element comprising a substrate and a thin film layer formed on the substrate. The thin film layer is for receiving and converting UV light into electricity for a photovoltaic output. First and second electrodes are formed on one surface of the thin film layer and are configured to form an electric polarization in the thin film layer between the first and second electrodes and to collect the photovoltaic output. There is also an amplifier and an output display. The UV sensing element is configured to collect the photovoltaic output, the amplifier being configured to receive the photovoltaic output from the UV sensing element, the output display being configured to provide a display when UV light is received at the one surface, the display being derived from the photovoltaic output.

According to another exemplary aspect there is provided a UV light dosimeter comprising a UV sensing element comprising a substrate and a thin film layer formed on the substrate. The thin film layer is for receiving and converting UV light into electricity for a photovoltaic output. First and second electrodes are formed on one surface of the thin film layer and are configured to form an electric polarization in the thin film layer between the first and second electrodes and to collect the photovoltaic output. There is also an amplifier, a capacitor for storing the photovoltaic output, a memory, and an output display. The output display is configured to provide a display representing the stored photovoltaic output in the capacitor and the information in the memory.

For both aspects, the first electrode and the second electrode form a pair of interdigital electrodes. The thin film layer may be a ferroelectric thin film. The output display may be one of: an LED and an LCD.

The UV detector may further comprise a first resistor in parallel with the UV sensing element. The UV detector may further comprise a second resistor in series with the output display and being configured to control a voltage magnitude to activate the output display.

The output display may be controlled by at least one of: photo-current magnitude and photo-voltage magnitude. The amplifier may be configured to convert the photo-current to an output voltage. The amplifier may be configured to convert the photo-voltage to an output voltage. The amplifier may be a voltage measurement unit without resistive gain in the output voltage.

The UV light detector may be a UV dosimeter for showing an accumulated dosage of UV light received at the one surface. The UV light detector may further comprise a capacitor configured to store photo-current. The output voltage of the amplifier may be an accumulated voltage of the capacitor during UV light radiation on the thin film. The amplifier may be a current integrator. A plurality of resistors may be in parallel with the capacitor for regulating a charging response speed of the capacitor. The UV light detector may further comprise a further resistor and a switch.

Voltage or current output from the UV sensor can be input to a microcontroller for computation of the actual UV radiation and the results may be shown in the display unit. The microcontroller is used to digitize analog voltage output from UV sensor. Computed parameters include a moving average of the input in real times, accumulative summing of the input over a period of times and making adjustments to eliminate any DC offset on the input voltage that may arise due to ambient disturbances. In addition, the microcontroller may store the gathered data on UV exposure in an internal or external memory storage device for future reference.

To obtain a highly accurate measurement of the actual UV exposure level, the microcontroller may also compensate for effects of temperature and other ambient disturbances by using output from an identical but unexposed UV sensing element as a baseline reference in the computation.

The UV detector may provide a user with flexibility by allowing changing of the sensing elements in applications where the UV sensor elements are to be used in a disposable manner.

### BRIEF DESCRIPTION OF THE DRAWINGS

In order that the invention may be fully understood and readily put into practical effect there shall now be described by way of non-limitative example only exemplary embodiments, the description being with reference to the accompanying illustrative drawings.

In the drawings:

FIG. 1(a) is an illustration of a photovoltaic device according to our earlier application for use as a UV sensing element;

FIG. 1(b) is an illustration of another photovoltaic device according to our earlier application for use as a UV sensing element;

FIG. 2 is a graph showing photo-voltage vs. UV wavelength of light for the sensing element of FIG. 1(b);

FIG. 3 is a graph of photocurrent vs. UV wavelength of light for the sensing element of FIG. 1(b);

FIG. 4 is a graph of photocurrent vs. UV intensity at wavelengths of light of 365 nm and 400 nm for the sensing element of FIG. 1(b);

FIG. 5 is an illustration of an exemplary circuit design using the sensing element of FIG. 1(a) or FIG. 1(b) with an LED as a output display;

FIG. 6 is an illustration of another exemplary circuit design using the sensing element of FIG. 1(a) or FIG. 1(b) with an LCD as the output display;

FIG. 7 is an illustration of a further exemplary circuit design using the sensing element of FIG. 1(a) or FIG. 1(b) to display accumulated UV radiation and therefore that functions as a UV dosimeter;

FIG. 8 is an illustration of a block diagram illustrating switching between UV sensor and dosimeter functionality;

FIG. 9 is an exemplary embodiment of a UV detector with a two-stage analogue signal processing circuit and microcontroller;

FIG. 10 is a preferred embodiment of the two-stage analog circuit of FIG. 9 for detection and amplification of UV sensor signal prior to microcontroller processing;

FIG. 11 is an alternative embodiment of the two-stage analogue circuit comprising an I-V converter circuit adopting a T-Network configuration at the negative feedback loop and a voltage amplifier with negative configuration;

FIG. 12 is an alternative embodiment of the two-stage analog circuit comprising an I-V converter with a single feedback resistor and a voltage amplifier with negative configuration;

FIG. 13 is an exemplary embodiment of a microcontroller in the UV detector;

FIG. 14 is an exemplary embodiment of a microcontroller system in the UV detector designed to take a reading of an unexposed UV sensing element as a baseline reference;

FIG. 15 is a process flowchart illustrating the operation of the microcontroller;

FIG. 16 is an exemplary embodiment of an analogue integrator circuit that accumulates the charge supplied by a two-stage analogue circuit prior to microcontroller processing; and

FIG. 17 is an exemplary embodiment of a UV detector featuring a detachable UV sensing element.

### DETAILED DESCRIPTION OF EXEMPLARY EMBODIMENTS

The UV detectors in the exemplary embodiments have a thin film sensor as described in our earlier application as the sensing element. The thin film is preferably a ferroelectric thin film.

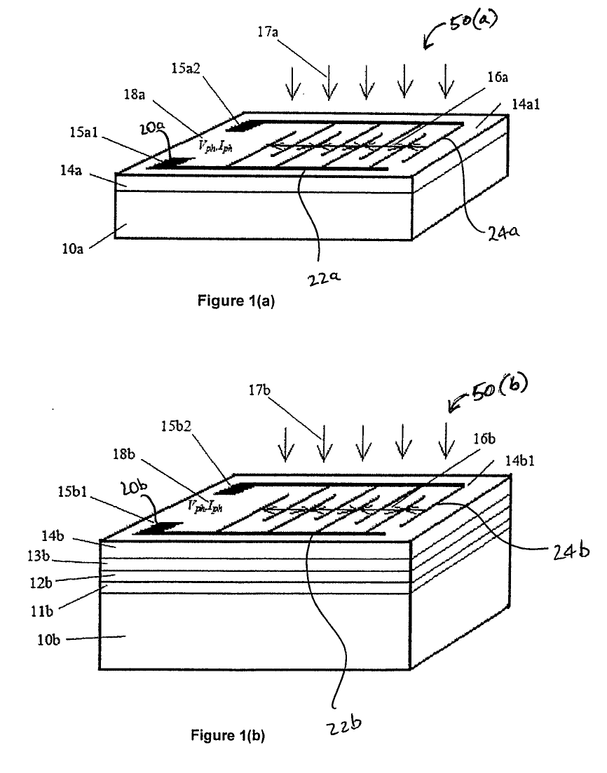

To first refer to FIGS. 1(a) and 1(b) there is shown two photovoltaic devices 50(a) and 50(b) respectively, both being according to our earlier application and both being for use as UV light sensing elements. Each sensing element 50(a) and (b) has a thin film layer 14a and 14b of a ferroelectric material formed on a substrate 10a and 10b respectively. In the exemplary embodiment of FIG. 1(a), one pair of electrodes, comprising first electrode 15a1 and second electrode 15a2, is formed on the ferroelectric thin film 14a and disposed apart from each other on the top surface 14a1 of the ferroelectric thin film layer 14a. In this embodiment, electrodes 15a1 and 15a2 form a pair of interdigital electrodes.

As such, the total current output between electrodes 15a1 and 15a2 is the collective value of the current between each pair of electrode fingers 24a. An electric field is applied at the terminals 20a and thus between electrodes 15a1 and 15a2 to polarize the ferroelectric thin film layer 14a between the electrodes 15a1 and 15a2. Preferably, polarization of the ferroelectric thin film layer 14a is parallel to a surface of the thin film layer between the electrodes 15a1 and 15a2. Alternately, the thin film layer 14a could be made of a polar material such as ZnO, ZnS, AlN, GaN, with electrical polarization existing between the electrodes 15a1 and 15a2 without poling by applying an electric field.

According to this embodiment, when a beam of UV light 17a illuminates the top surface 14a1 of the ferroelectric thin film layer 14a, a photo induced electric signal 18a (i.e. Vₚₕ and Iₚₕ) is generated between electrodes 15a1 and 15a2. The photovoltage able to be produced by this exemplary embodiment is not limited by one or more of: an energy barrier height of a p-n junction, and a Schottky barrier, as happens in semiconductor UV sensing elements. In this exemplary embodiment, the ferroelectric thin film layer 14a of the UV sensing element is exposed directly to light. This prevents light loss due to the light having to penetrate a top electrode layer.

The photovoltaic properties of the UV sensing element according to the exemplary embodiment were investigated under UV illumination with a mercury xenon lamp. The UV intensity was determined with a power meter calibrated at different wavelengths.

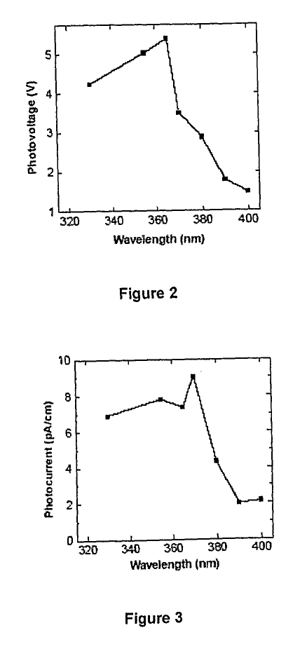

The dependences of photo-voltage and photocurrent on wavelength of light for the UV sensing element in FIG. 1(b) are shown in FIGS. 2 and 3, respectively. The light intensity was 0.38 mW/cm². FIG. 2 shows a photovoltage greater than 5 V, which is significantly large than that of a semiconductor photovoltaic element which is typically less than 1 V. The photo-current as shown in FIG. 3 is the current generated per unit length of the electrode fingers 24b in the interdigital electrodes 15b1 and 15b2. The results show that the UV sensing element has a photovoltaic response to UV light at a wavelength below 400 nm. The maximum photo-voltage and photo-current are observed at a wavelength of 365 nm, which corresponds to the energy bandgap of PLWZT.

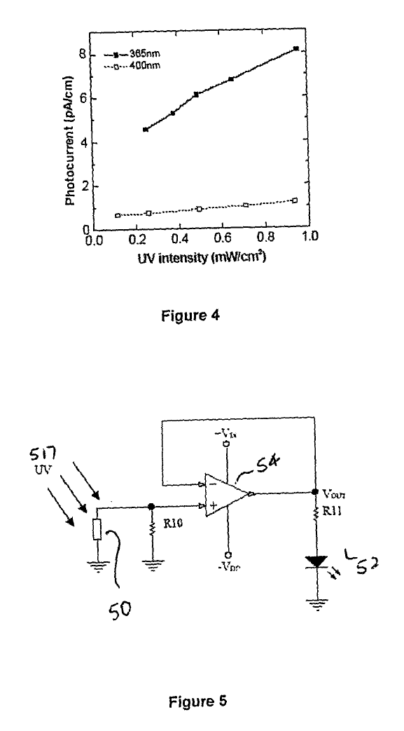

FIG. 4 shows the UV intensity dependence of photocurrent at wavelength of 365 nm and 400 nm. The photocurrent of the UV sensing element is substantially linearly proportional to UV intensity. The photocurrent as shown in FIG. 4 is the current generated per unit length of the electrode fingers 24b in the interdigital electrodes 15b1 and 15b2.

UV light radiation may be detected and displayed with UV detectors as disclosed below on the basis of the electrical output from the UV sensing element.

FIG. 5 shows a UV detector comprising the UV sensing element 50 and an LED 52 as the output display device to indicate the presence of UV radiation 517. The amplifier 54 functions as a voltage measurement unit without resistive gain in the output voltage. A large resistor R10 is in parallel with the UV sensor element 50 to improve the stability of the input voltage to the amplifier 54. Another resistor R11 in series with the LED 52 is chosen on the basis of the voltage magnitude required to activate the LED 52. With UV light 517 illuminating the UV sensing element 50, a voltage will be generated and thus the LED 52 is activated to indicate the presence of UV light 517.

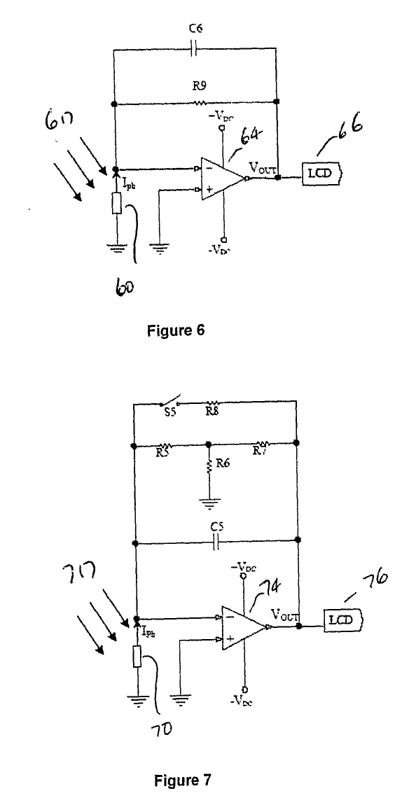

FIG. 6 shows another UV detector comprising the UV sensing element 60 and an LCD 66 as the output display device to indicate the intensity of UV light 617. The amplifier 64 is preferably a sensitive and low input current operational amplifier. It serves as a high impedance electrometer by allowing the current to flow into the resistor R9. The output voltage Vₒᵤₜ from the amplifier reflects the photocurrent Iₚₕ in the UV sensing element 60 according to a simple relationship: Vₒᵤₜ=−Iₚₕ×R9. As Iₚₕ is proportional to the intensity of UV light 617 and the value displayed on the LCD 66 is proportional to Vₒᵤₜ, the digits on the LCD 66 indicate the intensity of UV light 617. The sensitivity of the photocurrent detector can be adjusted by the resistance value of R9. A capacitance C6 is optionally connected in parallel with R9 to stabilize the circuit characteristics.

FIG. 7 shows a further UV detector that can display the accumulated UV radiation, thereby functioning as a UV dosimeter. The amplifier 74 is preferably a sensitive and low input current operational amplifier. It serves as a current integrator with high input impedance by allowing the photocurrent Iₚₕ to flow into the capacitor C5. The output voltage of the amplifier Vₒᵤₜ reflects the cumulative charges at C5. In this case, the capacitor C5 should be sufficiently large (e.g. 1 μF in the exemplary embodiment) to store the charge over a relatively long period. In parallel with C5, a combination of resistors R5, R6 and R7 is connected to regulate the charging response speed. As the effective resistance of the combination R5, R6 and R7 is high at approximately 1 GΩ and the discharge time is long, going into hours, a resistor R8 of 1 kΩ together with a switch S5 are optionally introduced as a discharge or reset for the UV dosimeter, whenever desired. Since the output voltage Vₒᵤₜ of the amplifier is proportional to the charge stored in C5, and the charge in C5 is proportional to the cumulative UV radiation, the digits displayed in the LCD 76 reflect the dosage of UV light 717 received by the UV sensing element 70.

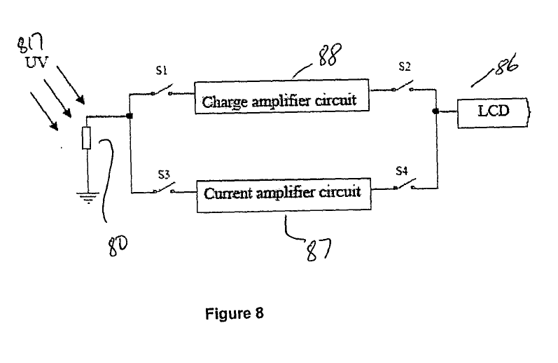

FIG. 8 is a general block diagram illustrating the switching between the sensor and dosimeter functions as shown in FIGS. 6 and 7, respectively. As shown in FIG. 8, the UV detector can detect both UV light 817 intensity and dosage with the one UV sensing element 80 and one output device, preferably an LCD 86. The UV sensing element and LCD can be switched between the current amplifier 87 similar to that of FIG. 6, and the charge amplifier 88 similar to that of FIG. 7. As such the LCD 86 can alternately or simultaneously display UV light 817 intensity or dosage.

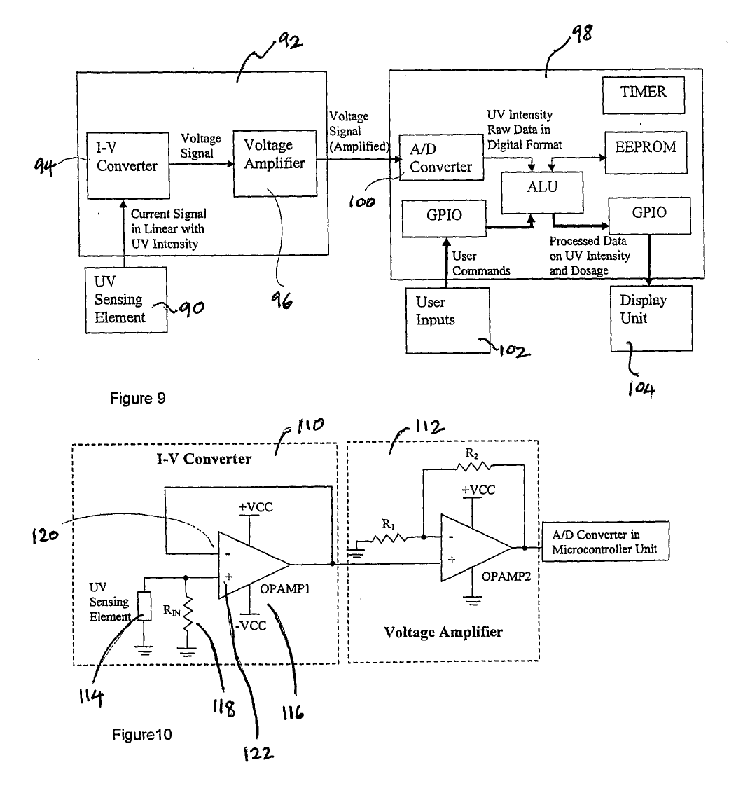

An exemplary embodiment of an improved UV detector is shown in FIG. 9. The detector comprises a UV sensing element 90 connected to a two-stage operational amplifier circuit 92. A current-to-voltage (I-V) converter 94 captures a current output in pico-nano amperes range from the UV sensing element 90 and translates the current output into a voltage output. The voltage output is channeled into a voltage amplifier 96 that amplified the output voltage, resulting in an amplified output. The amplified output is fed into a microcontroller 98 via an analog-to-digital converter 100 for signal processing. The microcontroller 98 can perform mathematical algorithms on the voltage input to compute an actual UV intensity and dosage. The microcontroller 98 is also configured to process commands input by a user via an input device 102, and to display computed results on a display unit 104. A preferred embodiment of the two-stage operational amplifier circuit (analogy circuit) in the UV detector is shown in FIG. 10. The circuit comprises of an I-V converter 110 (similar to the circuit shown in FIG. 5) as a primary stage and a voltage amplifier 112 as a secondary stage. In the I-V converter 110, a UV sensing element 114 is connected at a positive input terminal of an operational amplifier 116 and in parallel with a high value resistor R_{IN} 118 with a preferred value of 100 mega-ohms. This provides current output from the UV sensing element 114 with a high impedance input for I-V conversion. Output voltage of the first stage operational amplifier 116 is directly connected to its negative input terminal 120 to form a negative feedback loop in order to achieve high stability for the output voltage. Upon exposure to UV light, the output current from the UV sensing element 114 is channeled into the resistor R_{IN} 118 and creates a voltage that linearly with the output current from the UV sensing element 114 at the positive input terminal 122 of the operational amplifier 116. This voltage is reflected at the output of the operational amplifier 116 as Iₚₕ·R_{IN}. The operational amplifier 116 used for implementing the I-V converter 110 preferably has high precision and high input impedance characteristics. For the secondary stage, the operational amplifier adopts a positive configuration to boost the converted voltage output from the primary stage to a higher level.

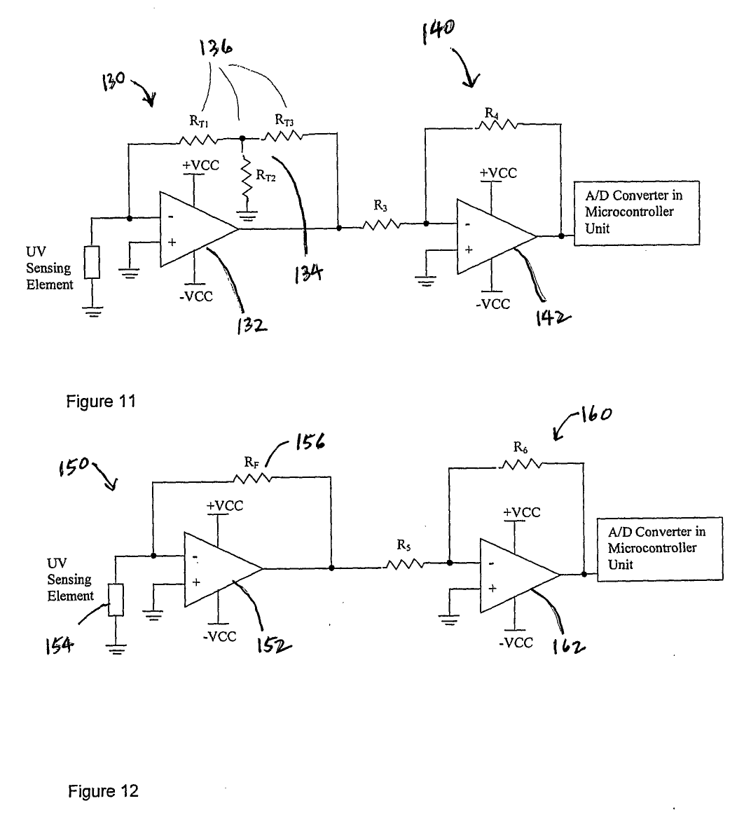

FIG. 11 shows an alternative embodiment of the two-stage analog circuit in which the primary stage for I-V conversion 130 comprises an operational amplifier 132 adopting a T-network 134 at the negative feedback resistive loop to provide high gain for the UV sensing element output current. In the exemplary embodiment of FIG. 11, values of the T-network resistors 136 can be 1 Giga-ohms, 100 K-ohms and 100 M-ohms for R_{T1}, R_{T2} and R_{T3} respectively. The operational amplifier 132 preferably has high precision and high impedance input characteristics. The secondary stage 140 operational amplifier 142 adopts a negative configuration so as to revert the negative voltage signal back to positive polarity before relaying to the microcontroller for processing.

FIG. 12 shows another alternative embodiment of a two-stage analog circuit in which the primary stage 150 operational amplifier 152 adopts a negative configuration for I-V conversion by receiving current output from a UV sensing element 154 at its negative input terminal. The output current from the UV sensing element 154 flows through a feedback resistor R_{F} 156 and produces a voltage of −Iₚₕ*R_{F} at the output of the operational amplifier 152. In the exemplary embodiment in FIG. 12, values of the feedback resistors R_{F} 156 can be 100 M-ohms and the operational amplifier 152 preferably has high precision and high impedance input characteristics. The secondary stage 160 operational amplifier 162 adopts a negative configuration so as to revert the voltage signal back to positive polarity before relaying to the microcontroller.

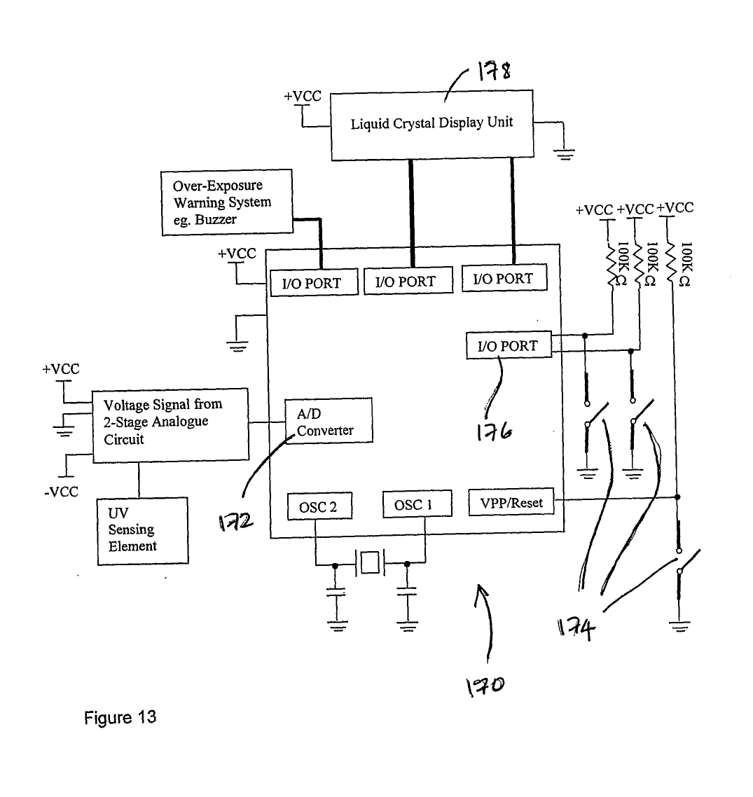

A preferred embodiment of the microcontroller 170 in the UV detector is shown in FIG. 13. Voltage output from the two-stage analog circuit is input into the microcontroller via an analog to digital converter 172 which can be a built-in module in the microcontroller 170 or an external integrated circuit device. The analog to digital converter 172 translates input analog voltage into a digital format, based on which the microcontroller 170 computes the UV exposure. In the exemplary embodiment in FIG. 13, the microcontroller 170 can also receive commands input by a user by means of switches 174 at an I/O port 176 of the microcontroller 170. The microcontroller 170 can also send computed data to a display unit 178 such as an LCD to present the UV exposure information to the user.

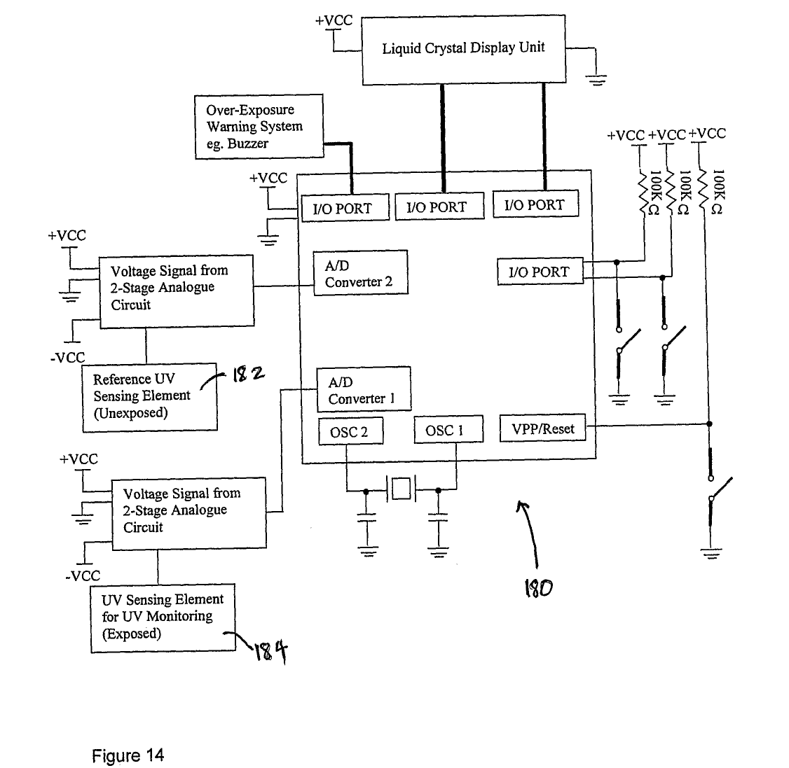

An alternative embodiment of the microcontroller 180 is shown in FIG. 14. The microcontroller 180 is configured to adjust for a DC offset level at the microcontroller input where exposure to UV light is being monitored. The DC offset level may arise from the two-stage analog circuits, temperature variations or other ambient noise. In order to cancel out the DC offset level, the microcontroller 180 takes a reading of an unexposed UV sensing element 182 as a baseline reference. The unexposed UV sensing element 182 should be identical to the UV sensing element 184 exposed for UV monitoring. Readings obtained from the exposed UV sensing element 184 for UV light monitoring are subtracted by the baseline reference level in order to yield a more accurate UV reading.

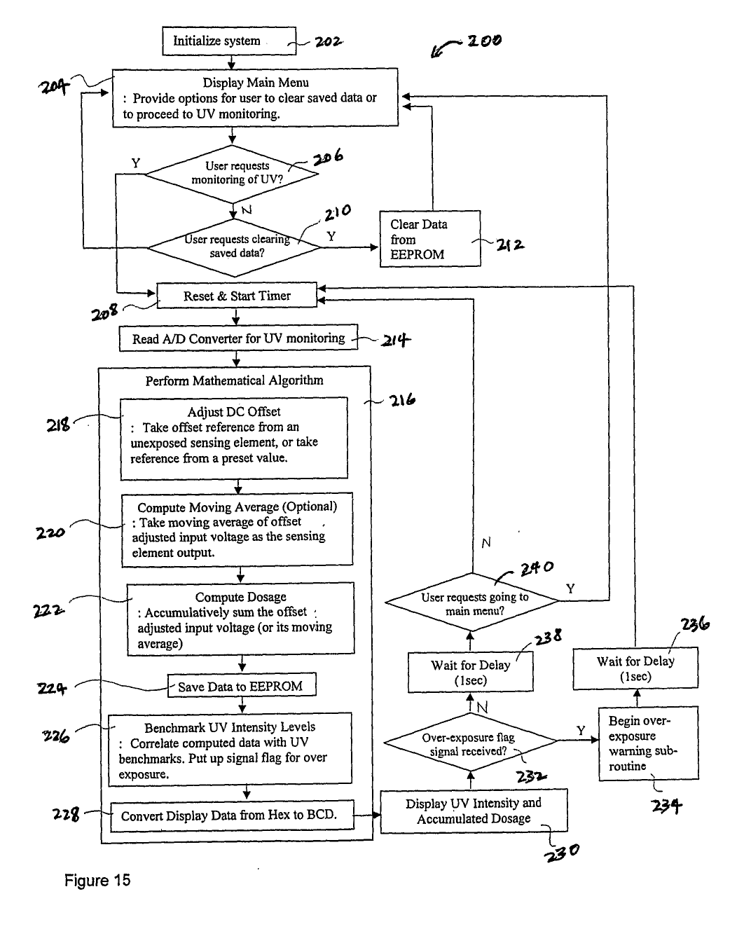

FIG. 15 is an exemplary process flowchart for the microcontroller. The process 200 comprises a series of events that may be executed by the microcontroller. Steps in the process are referenced with reference numerals in parentheses. To begin with, system initialization is performed (202). A main menu is then displayed (204) to provide a user with options to clear saved data from a previous session, or to proceed to UV monitoring. If the user decides to begin monitoring of UV (206), a timer is reset and started (208). If the user decides not to begin monitoring of UV, the user may request saved data to be cleared (210), whereupon data will be cleared from the EEPROM (212) and the process goes back to the step of displaying the main menu (204). When the timer has been reset and started at (208), an analog-to-digital converter is read (214) to obtain voltage readings from the output of the two-stage analog circuit.

The voltage readings are processed by a mathematical algorithm (216). The algorithm includes adjusting the DC offset (218) by taking an offset reference from an unexposed UV sensing element or taking reference from a preset value to result in an offset-adjusted input voltage. Optionally, a moving average (220) may be computed from the offset-adjusted input voltage as the output of the UV sensing element. The UV dosage is then computed (222) by accumulatively summing the offset-adjusted input voltage or its moving average. The UV dosage data is saved to EEPROM (224). Benchmarking of UV intensity levels (226) is performed by correlating computed data with UV benchmarks. A signal flag may be put up in case of over exposure. Display data is converted from Hex to BCD (228) and UV intensity and accumulated dosage is then displayed (230).

If an over-exposure flag signal was received (232), an over-exposure warning sub-routine is begun (234) and waiting for a delay of one second (236) takes place before looping back to resetting and starting the timer at (203). If no over-exposure flag was put up, wait for a delay of one second (238) also takes place. If a user requests going to the main menu (240), the process loops back to displaying the main menu (204). If no such request is made, the process loops back to resetting and starting the timer at (208). The process thus coordinates user interaction by checking for input by the user input at the I/O port periodically and activating specific events such as clearing data from EEPROM (212) upon a user's request.

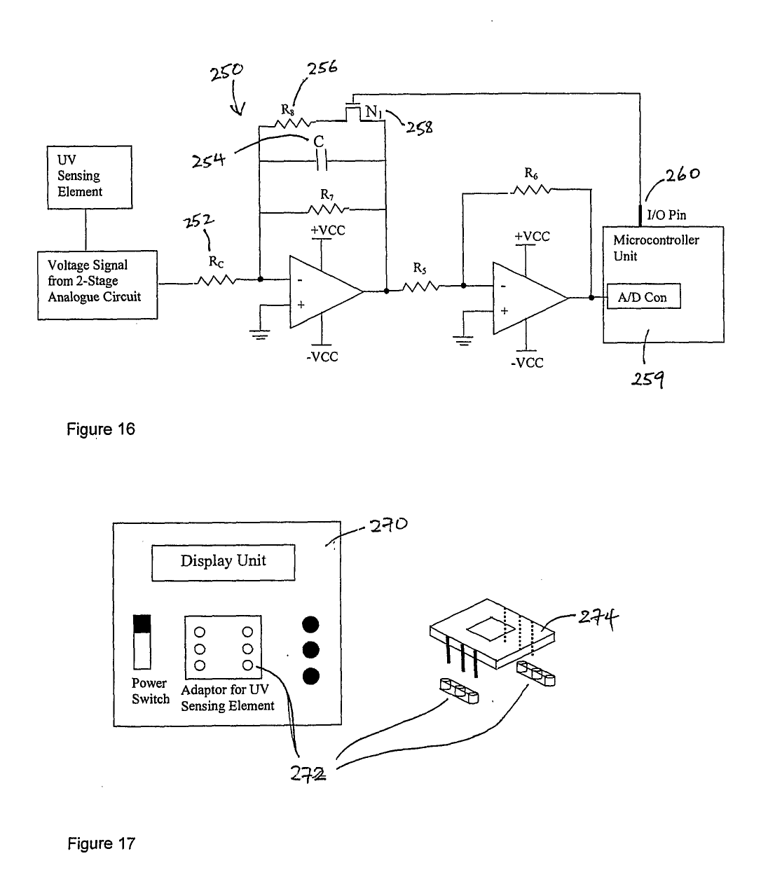

FIG. 16 shows an exemplary embodiment of an analog integrator circuit 250 that can be added to the UV detector so as to accumulate the charge supplied by the two-stage analog circuit over a time frame in order to provide an output voltage linearly with the dosage of UV exposure prior to the microcontroller processing. In the integrator circuit 250, a resistor R_{C} 252 and capacitor C 254 form a charging circuit over which the output voltage from the two-stage analog circuit can be accumulated gradually. In the exemplary embodiment, values of R_{C} and C may be as high as 10 K ohms and 100 uF respectively, so as to cater for a long charging duration before the integrator circuit 250 reaches saturation point. A resistor R₈ 256 and MOSFET switch N1 258 serves as a discharge path for the charging capacitor C 254. Upon reading the output voltage of the integrator circuit 250 at every interval, the microcontroller 259 can switch on the MOSFET switch N1 258 via an I/O pin 260 so that the accumulated voltage at the output of the integrator circuit 250 can be reset to zero. The integrator circuit 250 reduces required CPU times of the microcontroller 259 effectively as the microcontroller 259 can sense the input for UV monitoring at a longer interval while the integrator circuit 250 consolidates the accumulated UV exposure dosage.

The UV detectors, in accordance with the above-described embodiments, are reliable, user-friendly, compact and cost-effective. They can be miniaturized into handheld portable UV detectors powered by batteries or solar cells. They may even be further miniaturized into pendant size so that the UV detector can be worn by the user. As shown in FIG. 17, the UV detector 270 may provide the user with the flexibility of changing the UV sensing 274 element by having an adaptor 272 to hold the UV sensing element 274 and electrically connecting it with the UV detector 270. In this way, the UV sensing element 274 may be used in a disposable manner. Alternatively, the UV detector may also be integrated into any consumer electronics such as a mobile-phone or wrist-watch.

A ferroelectric material typically has a wide energy bandgap, and generally does not exhibit photovoltaic response to long wavelength light above UV range. Therefore, in principle, no expensive low-pass filter with UV transparency is required.

Whilst the foregoing description has described exemplary embodiments, it will be understood by those skilled in the technology concerned that many variations in details of design, construction and/or operation may be made without departing from the present invention.

1-41. (canceled)

42. An ultraviolet light detector comprising:
an ultraviolet sensing element comprising a substrate and a thin film layer formed on the substrate wherein the thin film layer is for receiving and converting ultraviolet light having a wavelength between 330 nm and 370 nm into electricity for a photovoltaic output, and first and second electrodes formed on one surface of the thin film layer and being configured to collect the photovoltaic output and the thin film layer having an electric polarization between the first and second electrodes;
an amplifier; and
an output display;
the ultraviolet sensing element being configured to generate and collect the photovoltaic output, the amplifier being configured to receive and amplify the photovoltaic output from the ultraviolet sensing element, the output display being configured to provide a display when ultraviolet light is received at the one surface, the display being derived from the photovoltaic output.

43. The ultraviolet light detector as claimed in claim 42, wherein the first electrode and the second electrode form a pair of interdigital electrodes.

44. The ultraviolet detector as claimed in claim 42, wherein the thin film layer is a ferroelectric thin film.

45. The ultraviolet detector as claimed in claim 42, wherein the electric polarization is parallel to a surface of the thin film layer between the first and second electrodes.

46. The ultraviolet detector as claimed in claim 44, wherein polarization in the ferroelectric thin film is produced by applying an electric field to pole the thin film through the first and the second electrodes.

47. The ultraviolet detector as claimed in claim 42, further comprising a first resistor in parallel with the ultraviolet sensing element and a second resistor in series with the output display and being configured to control a voltage magnitude to activate the output display.

48. The ultraviolet light detector as claimed in claim 42, wherein the output display is controlled by at least one selected from the group consisting of: photocurrent magnitude and photo-voltage magnitude; and the amplifier is configured to convert one of: the photo-current to an output voltage, and the photo-voltage to an output voltage.

49. The ultraviolet light detector as claimed in claim 48, wherein the amplifier is a voltage measurement unit without resistive gain in the output voltage.

50. The ultraviolet light detector as claimed in claim 48, wherein the ultraviolet light detector is an ultraviolet dosimeter for showing an accumulated dosage of ultraviolet light received at the one surface.

51. The ultraviolet light detector as claimed in claim 50, further comprising a capacitor configured to store photo-current, the output voltage of the amplifier being an accumulated voltage of the capacitor during ultraviolet light radiation on the thin film;
and the amplifier is a current integrator.

52. The ultraviolet light detector as claimed in claim 51, further comprising a plurality of resistors in parallel with the capacitor for realizing the current integrator function with the amplifier, and a further resistor and a switch.

53. The ultraviolet light detector as claimed in claim 42, further comprising a microcontroller configured to perform computations on output of the amplifier to produce computed output, the amplifier comprising a two-stage analog circuit and amplified voltage from the amplifier is able to be input into the microcontroller.

54. The ultraviolet light detector as claimed in claim 53, wherein a first stage of the two-stage analog circuit comprises a current-to-voltage converter in which current from the ultraviolet sensing element is channeled into a resistor connected between a positive input terminal of an operational amplifier and ground and output of the operational amplifier is channeled directly to a negative input terminal of the operational amplifier.

55. The ultraviolet light detector as claimed in claim 53, wherein a first stage of the two-stage analog circuit comprises a current-to-voltage converter having a T-network configuration at a resistive feedback loop.

56. The ultraviolet light detector as claimed in claim 53, wherein a first stage of the two-stage analog circuit comprises a current-to-voltage converter having a negative configuration in which output of a first operational amplifier is channeled to a negative input terminal of the first operational amplifier via a first resistor and into a negative input terminal of a second operational amplifier, and output of the second operational amplifier is channeled to the negative input terminal of the second operational amplifier via a second resistor.

57. The ultraviolet light detector as claimed in claim 53, wherein the microcontroller is configured to execute an algorithm for cancelling a DC offset level arising from an ambient disturbance, the algorithm comprising using an output of an unexposed ultraviolet sensing element as a baseline reference.

58. The ultraviolet light detector as claimed in claim 53, wherein the microcontroller is configured to execute an algorithm for cancelling a DC offset level arising from an ambient disturbance, the algorithm comprising subtracting a predetermined value from the output of the amplifier.

59. An ultraviolet light dosimeter comprising:
an ultraviolet sensing element comprising a substrate and a thin film layer formed on the substrate wherein the thin film layer is for receiving and converting ultraviolet light having a wavelength between 330 nm and 370 nm into electricity for a photovoltaic output, and
first and second electrodes formed on one surface of the thin film layer and being configured to collect the photovoltaic output and the thin film layer having an electric polarization between the first and second electrodes;
an amplifier; a capacitor for storing and accumulating the photovoltaic output; and
an output display; the output display being configured to provide a display representing the stored accumulated photovoltaic output in the capacitor.

60. The ultraviolet light dosimeter as claimed in claim 59, wherein the output display is controlled by at least one selected from the group consisting of: photo-current magnitude and photo-voltage magnitude; and the amplifier is configured to convert one of: the photo-current to an output voltage, and the photo-voltage to an output voltage.

61. The ultraviolet light dosimeter as claimed in claim 60, wherein the output voltage of the amplifier is accumulated voltage of the capacitor during ultraviolet light radiation on the thin film, the amplifier being a current integrator.

62. The ultraviolet light dosimeter as claimed in claim 59, wherein a plurality of resistors are in parallel with the capacitor for realizing the current integrator function with the amplifier, and further include a resistor and a switch.

63. The ultraviolet light dosimeter as claimed in claim 59, further comprising a microcontroller configured to perform computations on output of the amplifier to produce computed output.
